(19) United States
(12) Patent Application Publication
(10) Pub. No.: US 2011/0064010 A1
(43) Pub. Date: Mar. 17, 2011

(54) DIRECTIONAL COMMUNICATION ON MOBILE DEVICES

(75) Inventors: Lin Zhong, Houston, TX (US); Hasan Dumanli, Salihli (TR); Ashutosh Sabharwal, Houston, TX (US); Ardalan Amiri Sani, Mashhad (IR)

(73) Assignee: WILLIAM MARSH RICE UNIVERSITY, Houston, TX (US)

(21) Appl. No.: 12/560,166

(22) Filed: Sep. 15, 2009

(51) Int. Cl. H04B 7/00; H04B 1/38

(52) U.S. Cl. 370/310; 375/219

(57) ABSTRACT

In general, the invention relates to a wireless network interface card (WNIC). The WNIC includes an integrated circuit and a computer readable medium including executable instructions, which when executed by the integrated circuit perform a method, the method including selecting a first directional antenna of a number of directional antennas on a mobile communications device, sending a first data packet using the first directional antenna, and determining whether the first antenna is valid using a transmission strength threshold.

### STATEMENT REGARDING FEDERALLY SPONSORED RESEARCH OR DEVELOPMENT

This invention was made with Government Support under contracts CNS/NeTS-WN 0721894 awarded by the National Science Foundation. The United States Government may have certain rights in this invention.

### BACKGROUND

Numerous devices communicate wirelessly using wireless network interface cards, including cell phones and laptop computers. Generally, these devices are referred to as mobile devices. Mobile devices communicate with wireless networks by transmitting packets to network devices, such as base stations and access points, using a wireless network interface card. Generally, mobile devices radiate power into all directions for wireless transmission using an omni-directional antenna, such that transmitted data packets are received by at least one access point within range of the antenna. However, such omni-directional transmission leads to power waste and potential interference between devices because radiation is transmitted not only in the direction of the access point, but also in every other direction.

### SUMMARY

In general, in one aspect, the invention relates to a computer readable medium comprising executable instructions, which when executed by an integrated circuit, perform a method that includes selecting a first directional antenna of a plurality of directional antennas on a mobile communications device. The method further includes sending a first data packet using the first directional antenna, and determining whether the first antenna is valid using a transmission strength threshold.

In general, in one aspect, the invention relates to a wireless network interface card that includes an integrated circuit and a computer readable medium comprising executable instructions which when executed by the integrated circuit perform a method. The method includes selecting a first directional antenna of a plurality of directional antennas on a mobile communications device, sending a first data packet using the first directional antenna, and determining whether the first antenna is valid using a transmission strength threshold.

In general, in one aspect, the invention relates to a mobile device that includes an integrated circuit and a computer readable medium comprising executable instructions which when executed by the integrated circuit perform a method. The method includes selecting a first directional antenna of a plurality of directional antennas on a mobile communications device, sending a first data packet using the first directional antenna, and determining whether the first antenna is valid using a transmission strength threshold.

Other aspects of the invention will be apparent from the following description and the appended claims.

### BRIEF DESCRIPTION OF DRAWINGS

FIG. 1 shows a mobile device system in accordance with one or more embodiments of the invention.

FIGS. 2A-2B show flow diagrams in accordance with one or more embodiments of the invention.

FIGS. 3-4 show flow diagrams in accordance with one or more embodiments of the invention.

FIGS. 5A-5D show an example implementation of one or more embodiments of the invention.

FIG. 6 shows a mobile device system in accordance with one or more embodiments of the invention.

### DETAILED DESCRIPTION

Specific embodiments of the invention will now be described in detail with reference to the accompanying figures. Like elements in the various figures are denoted by like reference numerals for consistency. Further, the use of “Fig.” in the drawings is equivalent to the use of the term “Figure” in the description.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention are directed to directional communication on mobile devices. Specifically, embodiments of the invention are directed to utilizing directional antennas in a mobile device to transmit data from the mobile device using one of a series directional antennas. More specifically, embodiments of the invention relate to identifying a valid directional antenna for transmission of data packets.

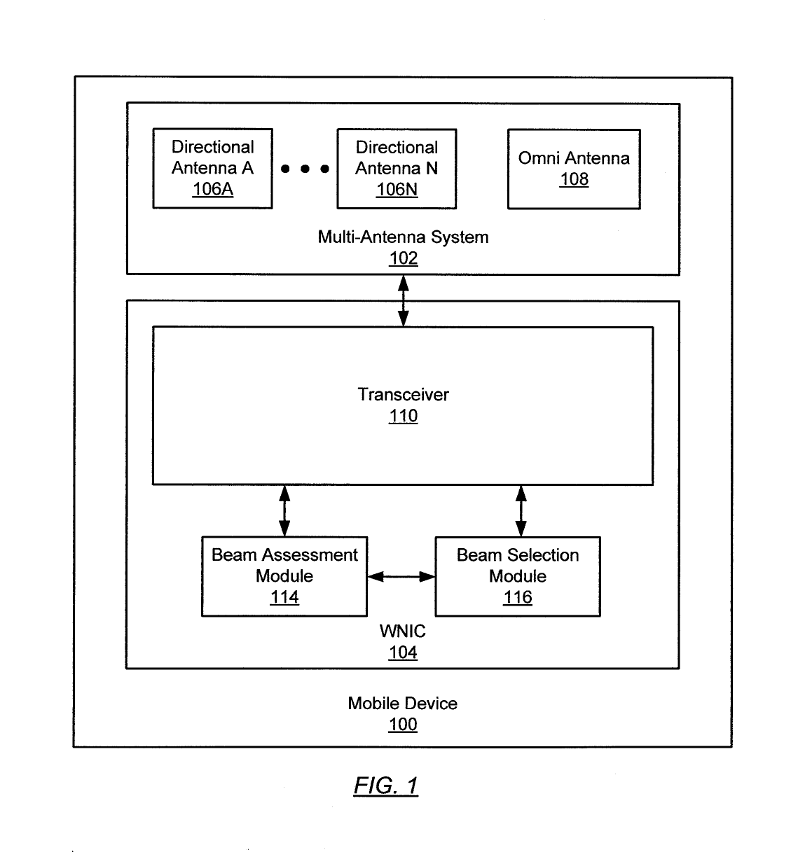

FIG. 1 shows a mobile device (100) according to one or more embodiments of the invention. Mobile device (100) includes a multi-antenna system (102) and a wireless network interface card (WNIC) (104). Examples of a mobile device include, but are not limited to, mobile phones (including smart phones), gaming devices, a media device (i.e., a portable television or DVD player, etc.), and laptop computers. Further, the mobile device (100) is not limited to those devices typically considered mobile devices and may include any other device that includes a WNIC and a multi-antenna system, such as a desktop computer, or any other mobile device, that has been configured to include the multi-antenna system and a WNIC.

In one embodiment of the invention, a WNIC is a network card, which connects to a radio-based network. The WNIC includes functionality to implement Layer 1 (i.e., the physical layer) and Layer 2 (i.e., the data link layer) of the of the Open System Interconnect Reference (OSI) Model. The WNIC may also implement other layers of the OSI Model including, but not limited to, Layer 4 (i.e., transport layer). In one embodiment of the invention, the WNIC uses antennas (discussed below) to communicate through microwaves. In one embodiment of the invention, the WNIC may be external to the mobile device (as opposed to integrated within the mobile device as shown in FIG. 1). In one embodiment of the invention, the WNIC connects to the mobile device using a universal serial bus (USB) interface.

Returning to FIG. 1, in one or more embodiments of the invention, the multi-antenna system (102) includes a number of directional antennas (e.g., 106A-106N) and an omni-directional antenna (108). The omni-directional antenna is used to receive packets from any direction. Each of the directional antennas (e.g., 106A-106N) is oriented towards a particular direction, such that the direction in which they transmit data packets is a fraction of the coverage of the omni-directional antenna (108). According to one or more embodiments of the invention, the directional antennas are used to send data packets and receive corresponding acknowledgment packets. Further, the directional antennas may also receive other packets in addition to the aforementioned acknowledgement packets (e.g., packets destined for other mobile devices in the network, beacon packets, packets broadcast over the control channel of the mobile network, etc). The omni-directional antenna is used to transmit and receive all other packets. However, the omni-directional antenna may also be used to transmit data packets (and receive corresponding acknowledgement packets), according to one or more embodiments of the invention, when an appropriate directional antenna cannot be identified.

For example, the directional antenna may send a request for data (via a data packet) to a base station. Assuming that the directional antenna is within range of the base station, the directional antenna receives the corresponding acknowledgement packet. While awaiting the acknowledgement packet, the directional antenna may receive other packets currently being transmitted across the network (including packets not specifically destined for the mobile device). In this example, once the acknowledgement packet is received, the transceiver switches to the omni-directional antenna in order to receive the requested data from the base station.

Continuing with FIG. 1, the following is an example related to the orientation of the directional antennas and is not intended to limit the scope of the invention. Consider a multi-antenna system comprising five directional antennas and one omni-directional antenna. According to one or more embodiments of the invention, each of the directional antennas covers a fraction of the 360 degrees covered by the omni-directional antenna. In one embodiment of the invention, each of the directional antennas covers at least 72 degrees. In this configuration, there is no overlap between transmission coverage of each of the directional antennas. However, according to one or more embodiments of the invention, there may be other configurations in which there is transmission coverage overlap between the directional antennas (e.g., each of the directional antennas covers more than 72 degrees). According to one or more embodiments of the invention, regardless of the orientation or coverage of the directional antennas, the aggregate transmission coverage of all of the directional antennas is the same as the coverage of omni-directional antenna.

Those skilled in the art will appreciate that there may be as few as two directional antennas oriented to transmit in opposite directions but no upper limited on the number of directional antennas. However, the number of directional antennas on a given WNIC may be limited (or otherwise determined) based on, for example, space constraints, power constraints, cost constraints, etc. Further, those skilled in the art will appreciate that each of the directional antennas may not have/be configured to operate with the same range of coverage. For example, one directional antenna may include 150 degrees of coverage, while another antenna may include only 50 degrees of coverage.

Continuing with FIG. 1, according to one or more embodiments of the invention, the WNIC (104) includes a single transceiver (110), a beam assessment module (114), and a beam selection module (116). The single transceiver (110) (e.g., a single Radio Frequency (RF) chain) is operatively connected to the multi-antenna system (102). According to one or more embodiments of the invention, the transceiver is able to use only one of the antennas (i.e., the directional antennas and the omni-directional antenna) at any given time.

In one or more embodiments of the invention, the beam assessment module (114) is configured to determine whether the directional antenna that is operatively connected to the transceiver is valid. Throughout this description, the directional antenna that is being used by the transceiver is referred to as the “current directional antenna.” According to one or more embodiments of the invention, the beam assessment module also receives data regarding packets received by the antennas in the multi-antenna system (102). The received packets are used to determine a transmission strength threshold. In one or more embodiments of the invention, the beam assessment module (114) uses the transmission strength threshold to determine whether the current directional antenna is valid (as defined below).

According to one or more embodiments of the invention, the beam assessment module (114) determines a transmission strength threshold using historical data regarding packets received by the antennas. The historical data may include the received signal strength indication (RSSI) of packets received by the antennas in the multi-antenna system. The aforementioned packets may correspond to packets received by the directional antennas and/or, as well as the omni-directional antenna. According to one or more embodiments of the invention, this historical data is stored in a data repository (not shown) on the WNIC (104). In one or more embodiments of the invention, the data repository is any type of volatile or non-volatile storage, which may internal or external to the mobile device.

The beam selection module (116) identifies and selects a directional antenna from which to send data packets, according to one or more embodiments of the invention. In one embodiment of the invention, the beam selection module (116) uses a beam selection algorithm to select a new directional antenna from which to transmit data packets when the current directional antenna is found to be invalid. A directional antenna may be invalid when it transmits data packets, but never receives acknowledgment packets corresponding to the sent data packets. Alternatively, or in addition to, a directional antenna may also be invalid when the transmission strength of the directional antenna falls below a transmission strength threshold (described below).

According to one or more embodiments of the invention, the beam selection module (116) first transmits packets from the current directional antenna. The initial directional antenna selected by the beam selection module (116) may be a default directional antenna according to one or more embodiments of the invention. For each packet transmitted by the current directional antenna, a corresponding acknowledgment packet is expected to be received by the current directional antenna. According to one or more embodiments of the invention, the beam assessment module (116) uses this received acknowledgment packet to determine whether the current directional antenna is valid. When the antenna is found to be invalid, the beam selection module (116) selects a new directional antenna from which to transmit data packets. According to one or more embodiments of the invention, the beam selection module (116) first selects one of the neighboring directional antennas of the current directional antenna. If that directional antenna is found to be invalid, then the beam selection module selects another neighbor of the original directional antenna. According to one or more embodiments of the invention, if the second neighboring directional antenna is also found invalid, then the beam selection module continues to try each of the remaining directional antennas at random until a valid antenna is found. According to one or more embodiments of the invention, if all directional antennas are found to be invalid, the beam selection module (116) begins again with the original directional antenna (or another one of the directional antennas).

While FIG. 1 shows a configuration of components, other configurations may be used without departing from the scope of the invention. For example, various components may be combined to create a single component. As another example, the functionality performed by a single component may be performed by multiple components.

Further, those skilled in the art will appreciate that the beam assessment module (114) and/or the beam selection module (116) may be implemented by the operating system (not shown) of the mobile device (100). In such cases, the WNIC (104) may interact with the beam assessment module (114) and/or the beam selection module (116) using appropriate driver(s) (not shown) and/or application programming interfaces (not shown).

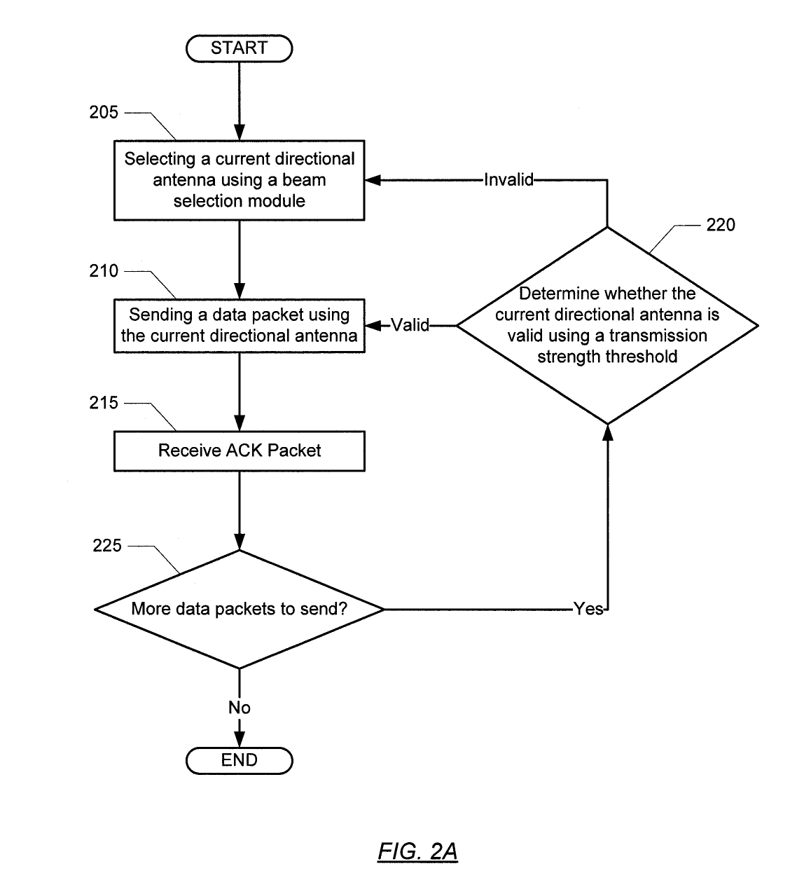

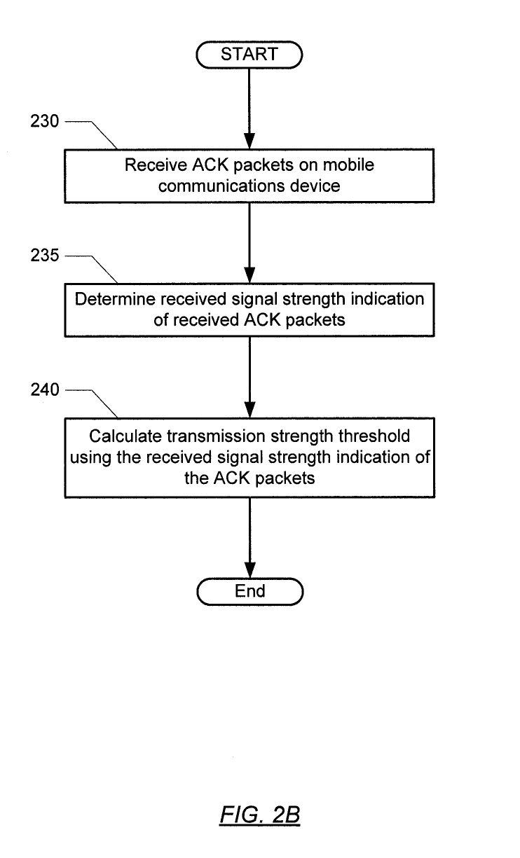

FIG. 2A shows a flow diagram according to one or more embodiments of the invention. Specifically, FIG. 2A shows, generally, how the beam selection module and the beam assessment module interact to transmit data packets at a given time. While the various steps in this flow diagram are presented and described sequentially, one of ordinary skill will appreciate that some or all of the steps may be executed in different orders, may be combined, or omitted, and some or all of the steps may be executed in parallel.

At Step 205, a directional antenna is selected using the beam selection module. The selected directional antenna may correspond to a default directional antenna. At Step 210, a data packet is sent using the current directional antenna.

At step 215, an acknowledgment (ACK) packet is received by the current directional antenna, where the ACK packet corresponds to the sent data packet is received. However, the ACK packet may not be received if the data packet is not received by the current directional antenna. Whether or not an ACK packet is received, the flow diagram continues at step 225, where a determination is made regarding whether additional data packets need to be sent. Because an ACK packet may have been received or not, there are two scenarios, in which additional data packets need to be sent. First, if the data packet was transmitted successfully (i.e., a corresponding ACK packet was received) and there are additional data packets to send, then the flow diagram continues at Step 220. Second, if no corresponding ACK packet is received, then the first data packet still needs to be transmitted, and, thus, there are additional data packets to send.

At step 220, a determination is made about whether the selected directional antenna is valid using a transmission strength threshold. As described above, the transmission strength threshold and whether a directional antenna is valid are determined by the beam assessment module, according to one or more embodiments of the invention. If the current directional antenna is found to be valid, then the flow diagram continues at Step 210, and another data packet is sent using the current directional antenna.

If at Step 220 the directional antenna is found to be invalid, then the flow diagram continues at Step 205, and a new directional antenna is selected using the beam selection module. According to one or more embodiments of the invention, the newly chosen directional antenna becomes the current directional antenna referred to in the flow diagram. The flow diagram continues until there are additional data packets to send.

FIG. 2B shows a flow diagram in accordance with one or more embodiments of the invention. Specifically, FIG. 2B shows an overview of how the transmission strength threshold is calculated. According to one or more embodiments of the invention, the transmission strength threshold is calculated by the beam assessment module. While the various steps in this flow diagram are presented and described sequentially, one of ordinary skill will appreciate that some or all of the steps may be executed in different orders, may be combined, or omitted, and some or all of the steps may be executed in parallel.

At Step 230, ACK packets are received on the mobile device. According to one or more embodiments of the invention, these received ACK packets refer to any packets received by the directional antennas in the multi-antenna system, which confirm that the data packet sent by the directional antenna was received. However, according to one or more embodiments of the invention, these packets may also refer to any such packets received by the omni-directional antenna. Those skilled in the art will appreciate that any packets (and not just ACK packets) may be may be used to determine a transmission strength threshold. Accordingly, although Step 230 refers to acknowledgment packets, the step may refer to any packets received by the mobile device.

At step 235, the received signal strength indication (“RSSI”) (or equivalent information) specified in the received packets is determined. Those skilled in the art will appreciate that the RSSI is a measure of power present in a received packet. According to one or more embodiments of the invention, data corresponding to the RSSI of received packets may be stored on the mobile device in volatile and/or non-volatile storage.

At step 240, the transmission strength threshold is calculated using the RSSI (and/or equivalent information) of the received packets. According to one or more embodiments of the invention, the threshold may be calculated by averaging the RSSI (and/or equivalent information) of the received packets (or a subset thereof) by the mobile device.

Consider an example in which the mobile device has received three data packets with RSSIs of 70, 76, and 82. In one embodiment of the invention, the transmission strength threshold would be 76. Accordingly, if a directional antenna receives a subsequent ACK packet with an RSSI of 65, the transmission strength of that directional antenna will be found to be below the transmission strength threshold. Further, the new transmission strength threshold will be updated to include the RSSI of 65. Accordingly, in this example, the new transmission strength threshold is 73.25. In one or more embodiments of the invention, before packets have been received on the mobile device, the system may store a default transmission strength threshold.

As discussed above, in one embodiment of the invention, the transmission strength threshold is determined using information from packets received by the various directional antennas as well as the omni-directional antenna. In such cases, in one embodiment of the invention, to compensate for the antenna gain difference between the directional and omni-directional antennas, a constant number is added to the RSSI of each received packet before it is stored and/or used to calculate the transmission strength threshold. The constant number is calculated as the average antenna gain difference between the directional and omni-directional antennas over the range of better gain.

Those skilled in the art will appreciate that the any packets (and not just acknowledgement packets) received by an active directional antenna (i.e., the directional antenna currently using the transceiver) may be used to determine the transmission strength threshold. For example, the active directional antenna may receive broadcast packets from a base station or access point and/or packets destined to other mobile devices from the base station or access point.

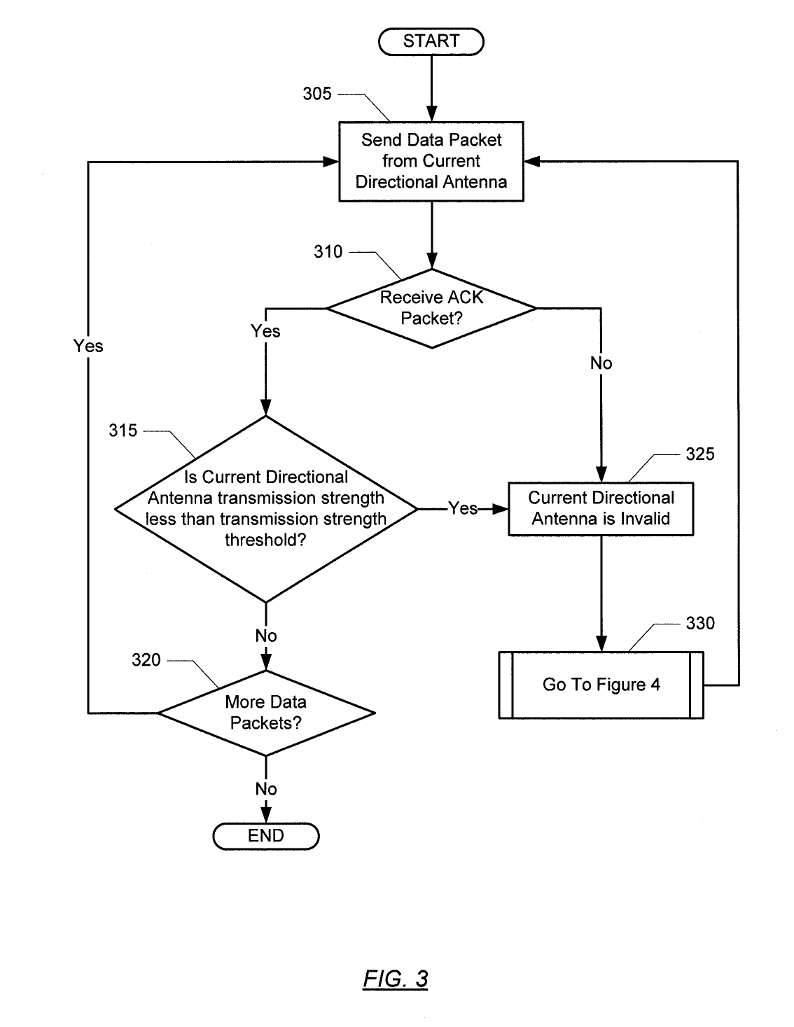

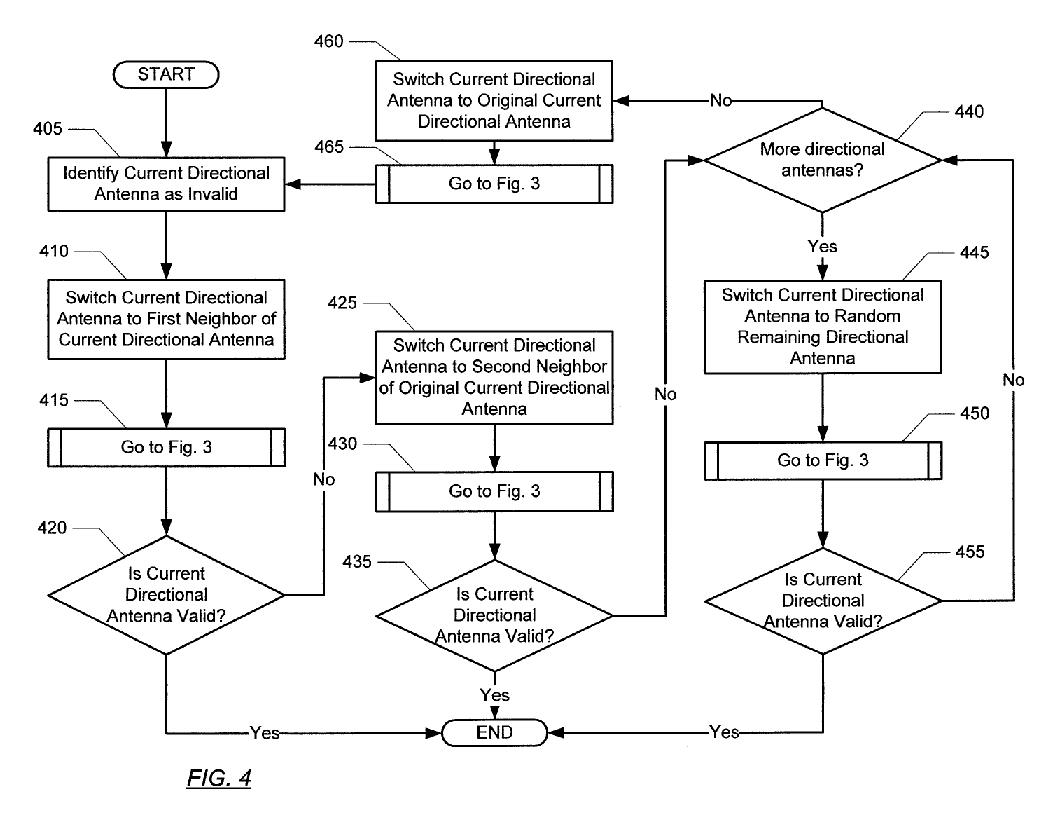

FIGS. 3 and 4 show a flow diagram according to one or more embodiments of the invention. Specifically, FIG. 3 shows a method for determining the validity of a specific directional antenna from the multi-antenna system in accordance with one embodiment of the invention. According to one or more embodiments of the invention, these steps are performed by the beam assessment module. Specifically, FIG. 4 shows a flow diagram detailing the steps involved in selecting a directional antenna, according to one or more embodiments of the invention. According to one or more embodiments of the invention, these steps are performed by the beam selection module. While the various steps in the flowcharts are presented and described sequentially, one of ordinary skill will appreciate that some or all of the steps may be executed in different orders, may be combined, or omitted, and some or all of the steps may be executed in parallel.

Referring to FIG. 3, at Step 305, a data packet is sent from the current directional antenna. At step 310, a determination is made regarding whether an ACK packet corresponding to the sent data packet has been received by the directional antenna. At step 315, if the ACK packet is received, then a determination is made about whether the transmission strength on the current directional antenna is less than the transmission strength threshold (for example, as calculated in FIG. 2B).

If it is determined that the current directional antenna transmission strength is not less than the transmission strength threshold, then at Step 320, a determination is made whether additional packets need to be transmitted. The flow diagram continues again at Step 305 by sending the next data packet until no additional data packets are left to transmit.

Returning to Step 310, if a determination is made that no ACK packet corresponding to a sent data packet is received, then the flow diagram continues at Step 325. At Step 325, the current directional antenna is found to be invalid. It is important to note that, returning to Step 315, if the current directional antenna transmissions strength is less than the transmission strength threshold, the flow diagram also continues at Step 325 and the current directional antenna is found to be invalid.

The flow diagram proceeds from Step 325 and Step 330, which requires the flow diagram to continue in FIG. 4. Specifically, once the current directional antenna is found to be invalid, a new directional antenna must be chosen by the beam selection module.

Referring to FIG. 4, at Step 405, the current directional antenna is found to be invalid. According to one or more embodiments of the invention, this step may be duplicative of Step 325 in FIG. 3. However, it is important to note that the steps performed in FIG. 3 are not necessarily performed before the steps recited in FIG. 4.

At step 410, the current directional antenna is switched to the first neighbor of the current directional antenna. At Step 415, the flow diagram returns to FIG. 3. Returning to FIG. 3, the flow diagram begins at Step 305. At Step 305, data packets are sent using the current directional antenna. It is important to note that this current directional antenna is not the same as the directional antenna identified as invalid in Step 405. Rather, now the current directional antenna is the first neighbor of the identified directional antenna in Step 405. According to one or more embodiments of the invention, the flow diagram shown in FIG. 3 continues until this new current directional antenna is found to be invalid. At Step 330, when this new current directional antenna is found to be invalid, the flow diagram continues at FIG. 4.

According to one or more embodiments of the invention, where in FIG. 4 the flow diagram continues from FIG. 3 is dependent upon the assessment of the new current directional antenna (i.e., the first neighbor of the original directional antenna). According to one or more embodiments of the invention, if the first neighbor of the original directional antenna is found to be invalid on the first iteration, or some minimal number of iterations, of the flow diagram of FIG. 3, then the flow diagram returns to FIG. 4 at Step 420. However, according to one or more embodiments of the invention, if the first neighbor of the original antenna is not found to be invalid in the first iteration of sending data packets, or within some minimal number of iterations, then when the first neighbor of the original directional antenna becomes invalid, the flow diagram continues in FIG. 4 and Step 405. Accordingly, when the first neighbor successfully transmits some number of packets, with respect to FIG. 4, it then becomes the current directional antenna.

Considering the scenario where the first neighbor of the original directional antenna did not successfully transmit packets before being found to be invalid at Step 330, then the flow diagram continues at Step 420. Because the current directional antenna is found to be invalid, the flow diagram continues at Step 425. At Step 425, the current directional antenna is switched to the second neighbor of the original directional antenna. Further, in this example, the original current directional antenna became invalid, and the first neighbor of the original directional antenna was found to be invalid. Thus, the second neighbor of the original directional antenna is selected.

At Step 430, once the second neighbor of the original directional antenna is selected, the flow diagram continues at FIG. 3. Accordingly, data packets are sent from the second neighbor of the original directional antenna until the second neighbor of the original directional antenna is found to be invalid. Similarly, at Step 415, when the second neighbor of the original directional antenna is successful in transmitting some minimal number of data packets, the second neighbor of the original directional antenna becomes invalid at Step 330. This occurs, for example, when a data packet was sent from the directional antenna, and an acknowledgment packet corresponding to that data packet was received, and the transmission strength of the directional antenna is not below the transmission strength threshold. The flow diagram continues at Step 405 in FIG. 4.

However, for purposes of fully explaining this flow diagram, the flow diagram returns to Step 435 and determines that the second neighbor of the original directional antenna was unsuccessful in transmitting a minimal number of data packets before being found invalid. Accordingly, the flow diagram continues at Step 440.

At Step 440, a determination is made whether there are additional directional antennas that have not been selected and assessed for validity. According to one or more embodiments of the invention, there may be as few as two directional antennas. Accordingly, if both directional antennas have been found to be invalid, then the flow diagram continues at Step 460, and the current directional antenna is switched back to the original directional antenna (i.e., the directional antenna that was the current directional antenna at Step 405). At Step 465, the validity of the original directional antenna is again assessed using the steps of FIG. 3. Upon finding that the original directional antenna is invalid, then the flow diagram begins again at Step 405.

Returning to Step 440, if there are more directional antennas (i.e., if there are more than two directional antennas), the flow diagram continues at Step 445. At Step 455, the current directional antenna is switched to a random one of the remaining directional antenna. Alternatively, according to one or more embodiments of the invention, the directional antenna selected may be selected using any selection algorithm.

At Step 450, the validity of the new current directional antenna (i.e., the first randomly selected antenna), is assessed using the steps shown in FIG. 3. Again, if the current directional antenna successfully transmits a minimum number of data packets (i.e., sends a data packet and receives an acknowledgment packet corresponding to the data packet, and the transmission strength is not below the transmission strength threshold), then upon finding that the current directional antenna is invalid at Step 330, the flow diagram continues at Step 405. However, if the current directional antenna does not successfully transmit a minimum number of data packets, then the current directional antenna is found to be invalid at Step 455.

At step 455, upon determining that the current directional antenna is invalid, the flow diagram continues at Step 440, where a determination is made whether there are any remaining directional antennas that have not been assessed. Steps 440-455 continue either until a valid antenna is found, or until all directional antennas have been assessed. At Step 440, once all directional antennas have been assessed, and no valid antenna has been found, then the flow diagram continues at Step 460, and the original directional antenna is selected. At Step 465, the original directional antenna (or another one of the directional antennas) is assessed using the steps in FIG. 3. According to one or more embodiments of the invention, if a valid directional antenna is not identified within a specified time period, omni-directional antenna may be used to transmit the data packet.

Those skilled in the art will appreciate that while FIGS. 3 and 4 described a process for (i) selecting a directional antenna, (ii) determining whether the selected directional antenna is valid, and (iii) selecting another directional antenna if the currently selected directional antenna is not valid using the following selection order: (a) try first neighbor of selected directional antenna, (b) try second neighbor of selected directional antenna, and (c) try remaining directional antennas at random, that any other process of selecting a directional antenna may be used.

For example, according to one or more embodiments of the invention, selecting a next directional antenna may involve considering data regarding the motion and direction of the mobile device to anticipate the direction of the target of the data packets, as well as the corresponding directional antenna in the mobile device. For example, if a mobile device is equipped with a component that detects movement of the device, such as a compass, an accelerometer(s), and/or a Global Positioning System (and/or other components that detect/estimate the movement/location/rotation of the mobile device), data from such components may also be considered in selecting the next directional antenna. For example, if data from a GPS component in the mobile device identifies that the device is moving east, and a current directional antenna becomes invalid, the first neighbor selected may be the directional antenna facing east. Those skilled in the art will appreciate that an accelerometer(s) and/or compass may be used to identify whether a mobile device has been rotated (along any axis) while remaining in the same location.

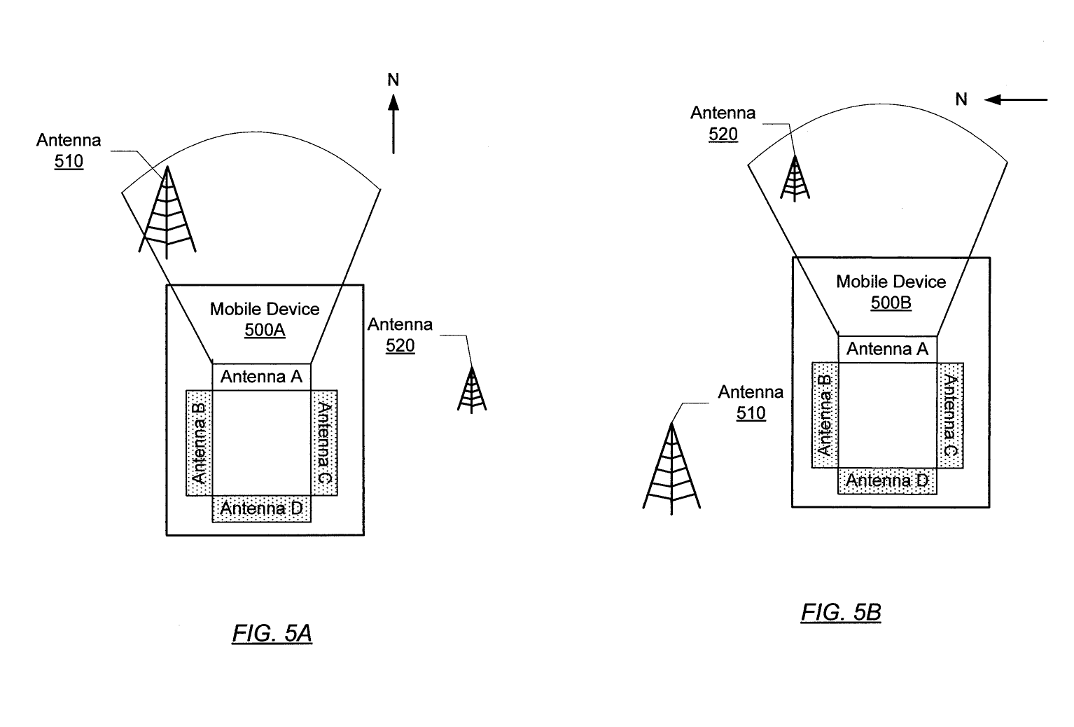

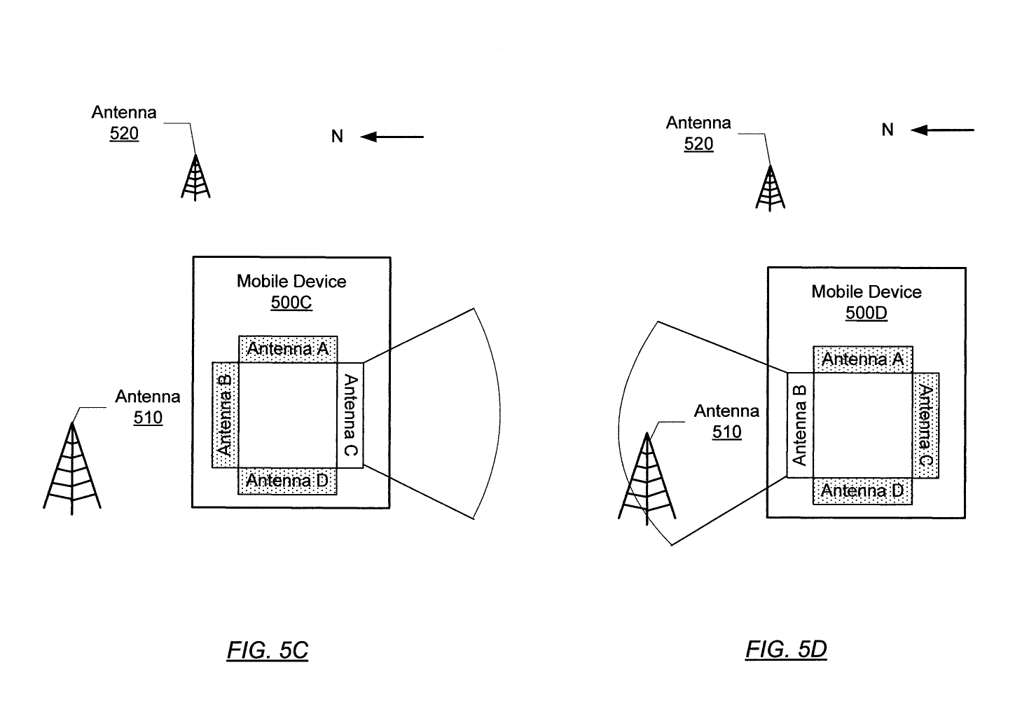

FIGS. 5A-5D show an example according to one or more embodiments of the invention. The following example is for explanatory purposes only and not intended to limit the scope of the invention.

The example begins with FIG. 5A. FIG. 5A includes a mobile device (500A), a first tower (510) that lies closer to the mobile device (500A), and a second tower (520) that lies farther away from the mobile device (500A) at a time t1. Although towers are shown in the example, those skilled in the art that the towers may refer to any target of data packets sent from the mobile device. The example mobile device (500A) includes four directional antennas, Antenna A-D. According to one or more embodiments of the invention, the mobile device also includes an omni-directional antenna (not shown).

In FIG. 5A, the mobile device (500A) is facing north. Antenna A is also facing north toward the first tower (510). At this time, the mobile device (500A) is facing north and is transmitting data packets to the first tower (510) using Directional Antenna A.

FIG. 5B shows that mobile device (500B) at time t2. At time t2, mobile device (500B) has been rotated and is now facing east. Accordingly, Directional Antenna A is no longer able to transmit data packets to the first tower (510). However, the second tower (520) is within the reach of Directional Antenna A. Accordingly, a first data packet is sent to the second tower (520) and a corresponding acknowledgement is received. Assume for purposes of this example that the transmission strength of Directional Antenna A is below the transmission strength threshold. Because Directional Antenna A is found to have inadequate transmission strength at t2, Directional Antenna A is deemed invalid.

As described above in FIG. 4, once Directional Antenna A is found to be invalid, the current directional antenna is switched to a first randomly selected neighbor (i.e., Directional Antenna C, in this example) of Directional Antenna A.

FIG. 5C shows the result of this switch at a time t3. Once the mobile device has selected Directional Antenna C, Directional Antenna C is assessed as described above. It is important to recall that the data packet sent from Directional Antenna A and received at the second tower (520) was acknowledged as received, and Directional Antenna A was found to be invalid not because packets failed to reach their destination, but because the transmission strength of Directional Antenna A was below the transmission strength threshold. Accordingly, in assessing Directional Antenna C, the first data packet does not have to be resent.

Assessing Directional Antenna C begins by sending a second data packet. For purposes of this example, assume that Directional Antenna C would not receive an acknowledgment packet because there is no tower within range to receive the second data packet. Accordingly, Antenna C is found to be invalid, and another directional antenna must be selected.

FIG. 5D shows the results of selecting another directional antenna at time t4. Because the first neighbor of the original directional antenna (i.e., Directional Antenna A) has already been selected, the second neighbor (i.e., Directional Antenna B) of the original directional antenna is selected. Upon selecting Directional Antenna B as the new directional antenna, Directional Antenna B is assessed.

It is important to note that because the second data packet was never received by a tower, the second data packet must be resent to ensure delivery, according to one or more embodiments of the invention. In this case, Directional Antenna B transmits the second data packet. The first tower (510) is now within range of Directional Antenna B and, accordingly, receives the second data packet. Directional Antenna B subsequently sends an acknowledgment packet back to the mobile device.

Following the issuance of the acknowledgment packet from the second two one of two scenarios may occur. In one scenario, the second tower (510) is determined to be within sufficient range of the mobile device (500D) that the transmission strength of Directional Antenna B is not below the transmission strength threshold. Accordingly, further data packets are sent using Antenna B until it is found to be invalid.

In a second scenario, referring to FIG. 5D, Directional Antenna B is found to be invalid, either because an acknowledgement was not received by the second tower (510) or because Directional Antenna B has insufficient transmission strength. In either case, another directional antenna is selected. In this example, Directional Antenna D is selected (as all other directional antennas in the mobile device) have been selected. Subsequently, Directional Antenna D is assessed as described above.

Those skilled in the art will appreciate that in one embodiment of the invention, an omni-directional antenna may be initially used to determine the locations of the various towers with respect to the mobile device. Once this determination is made, the aforementioned information may be used to select directional antennas for subsequent data transmission. Further, when a given directional antenna is found to be invalid, the selection of another directional antenna may be made based, in part, on the aforementioned information obtained using the omni-directional antenna.

Those skilled in the art will appreciate that while the invention has been described with respect to determining the validity of a given directional antenna using acknowledgement packets, embodiments of the invention may extended to encompass using other packets received by the directional antenna to determine its validity. For example, the transmission strength of the directional antenna may be determined by obtaining RSSI (or equivalent data) from the received packets. The RSSI information may then be compared to the corresponding transmission strength threshold to determine whether the directional antenna is valid.

Embodiments of the invention may reduce power consumption of the mobile device (or any other device that includes a WNIC) with the functionality described above by reducing the amount of power required to transmit data packets. In one or more embodiments of the invention, because the mobile device does not need to spread transmission power towards all directions, the transmission power required to transmit the data packets is reduced. Further, the reduction in the transmission of data packets in all directions may result in a reduction of inter-device interference, and therefore allow a network to accommodate more devices. Further, each mobile device, in accordance with one or more embodiments of the invention, may be allowed higher network performance.

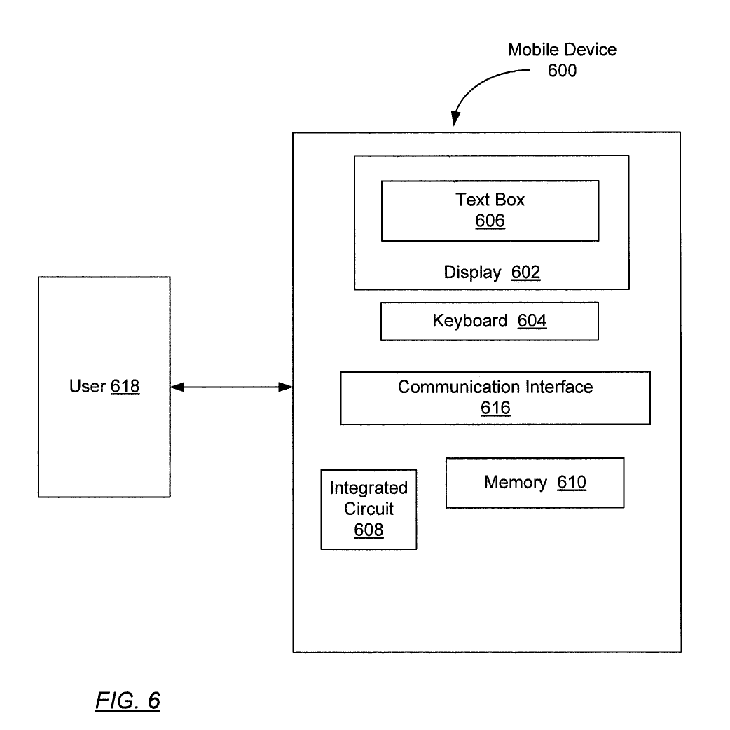

FIG. 6 shows a mobile device in accordance with one or more embodiments of the invention. As shown in FIG. 6, the mobile device (600) includes output means, such as a display (602), an input means, e.g., a keyboard (604), an integrated circuit (e.g., a processor) (608) (or any other component configured to execute instructions), associated memory (610), a communication interface (616), and numerous other elements and functionalities typical of today's mobile devices (not shown). Those skilled in the art will appreciate that the input and output means may take other forms, now known (e.g., a virtual keyboard) or later developed. The mobile device (600) may be a computer system, a laptop, a media device (i.e., a portable television or DVD player, etc), a gaming device, a mobile phone (including a smart phone), a personal digital assistant, or any other suitable wireless mobile device.

The display (602) may be a liquid crystal display (LCD) or any other type of suitable user interface. The display (602) includes a text box (606) for displaying text on the mobile device. That is, the display (602) is an interface configured to display a text box (606). The text box (606) is a text input area for composing messages on the mobile device, such as electronic mail messages, short messaging service (SMS) messages or text messages, etc. Those skilled in the art will appreciate that the text box (606) may also be used to display text for a user of the mobile device, such as notifications/alerts, a greeting message, the current date/time, etc.

Text is input into the mobile device using a keyboard (604) associated with the mobile device (600). The inputted text is subsequently displayed in the text box (606). The keyboard may be a wired keyboard, a wireless keyboard, a virtual keyboard, a keypad, or any other type of suitable input device that includes keys that are pressed to input data. The keyboard may be a full keyboard with all standard keys included, or may be a partially equipped keyboard that includes a subset of the keys typically included on a full keyboard. Further, the keyboard may be a QWERTY, English-based keyboard, a modified version of the QWERTY keyboard for international use (i.e., an English-international layout), or an extended keyboard with extended characters (i.e., an English-extended layout). Those skilled in the art will appreciate that the invention may also be implemented with foreign-language keyboards.

The mobile device includes an integrated circuit (608) for executing applications and software instructions configured to perform various functionalities, and memory (610) for storing program instructions and application data. Software instructions to perform embodiments of the invention may be stored on any tangible computer readable medium such as a compact disc (CD), a diskette, a tape, a memory stick such as a jump drive or a flash memory drive, or any other physical computer or machine readable storage device that can be read and executed by the integrated circuit (608) of the mobile device.

The memory (610) may be flash memory, a hard disk drive (HDD), persistent storage, random access memory (RAM), read-only memory (ROM), any other type of suitable storage space, or any combination thereof.

In one embodiment of the invention, the communication interface (616) includes a WNIC. Further, the communication interface may also include a serial port, a parallel port, a universal serial bus (USB) interface, or any type of network interface connection, such as Bluetooth® (Bluetooth is a registered trademark of Bluetooth SIG, Inc.), infrared signal, etc. Further, the communication interface may also support Global System for Mobile (GSM) communications, and 3G and/or 4G standards for mobile phone communication. In one or more embodiments of the invention, the mobile device (600) may be connected to a local area network (LAN) or a wide area network (e.g., the Internet) (not shown) via the communication interface (616). Further, the communication interface (616) may support both wired and wireless interfaces.

Those skilled in the art will appreciate that embodiments of the invention may be implemented in firmware on the WNIC and/or mobile device. In addition, embodiments of the invention may be implemented entirely in hardware. For example, the beam selection module and the beam assessment module may be implemented entirely in hardware (as opposed to being implemented as a software/hardware combination).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer readable medium comprising executable instructions, which when executed by an integrated circuit perform a method, the method comprising:
selecting a first directional antenna of a plurality of directional antennas on a mobile communications device;
sending a first data packet using the first directional antenna; and
determining whether the first antenna is valid using a transmission strength threshold.

2. The computer readable medium of claim 1, wherein determining whether the first directional antenna is valid comprises determining whether a first acknowledgment packet corresponding to the first data packet is received by the first directional antenna.

3. The computer readable medium of claim 1, wherein determining whether the first directional antenna is valid comprises:
determining a first transmission strength corresponding to the first directional antenna using the first acknowledgment packet; and
determining whether the first transmission strength is less than a transmission strength threshold.

4. The computer readable medium of claim 3, wherein determining whether the transmission strength threshold is determined by calculating an average of the transmission strength signal indicator of at least one received packet received prior to the first acknowledgment packet on the mobile communications device.

5. The computer readable medium of claim 1, the method further comprising:
determining a first transmission strength corresponding to the first directional antenna using the first acknowledgment packet;
when the first transmission strength is less than the transmission strength threshold:
selecting a second directional antenna;
sending a second data packet from the second directional antenna; and
determining whether the second directional antenna is valid using the transmission strength threshold.

6. The computer readable medium of claim 5, wherein the first directional antenna and the second directional antenna use a single transceiver.

7. The computer readable medium of claim 5, wherein the second directional antenna is adjacent to the first directional antenna.

8. A wireless network interface card comprising:
an integrated circuit; and
a computer readable medium comprising executable instructions, which when executed by the integrated circuit perform a method, the method comprising:
selecting a first directional antenna of a plurality of directional antennas on a mobile communications device;
sending a first data packet using the first directional antenna; and
determining whether the first antenna is valid using a transmission strength threshold.

9. The wireless network interface card of claim 8, wherein determining whether the first directional antenna is valid comprises determining whether a first acknowledgment packet corresponding to the first data packet is received by the first directional antenna.

10. The wireless network interface card of claim 8, wherein determining whether the first directional antenna is valid comprises:
determining a first transmission strength corresponding to the first directional antenna using the first acknowledgment packet; and
determining whether the first transmission strength is less than a transmission strength threshold.

11. The wireless network interface card of claim 10, wherein determining whether the transmission strength threshold is determined by calculating an average of the transmission strength signal indicator of at least one received packet received prior to the first acknowledgment packet on the mobile communications device.

12. The wireless network interface card of claim 8, the method further comprising:
determining a first transmission strength corresponding to the first directional antenna using the first acknowledgment packet;
when the first transmission strength is less than the transmission strength threshold:
selecting a second directional antenna;
sending a second data packet from the second directional antenna; and
determining whether the second directional antenna is valid using the transmission strength threshold.

13. The wireless network interface card of claim 12, wherein the first directional antenna and the second directional antenna use a transceiver.

14. The wireless network interface card of claim 12, wherein the second directional antenna is adjacent to the first directional antenna.

15. The wireless network interface card of claim 12, wherein the second directional antenna is randomly selected from the plurality of directional antennas.

16. A mobile device comprising:
an integrated circuit; and
a computer readable medium comprising executable instructions, which when executed by the integrated circuit perform a method, the method comprising:
selecting a first directional antenna of a plurality of directional antennas on a mobile communications device;
sending a first data packet using the first directional antenna; and
determining whether the first antenna is valid using a transmission strength threshold.

17. The mobile device of claim 16, wherein determining whether the first directional antenna is valid comprises determining whether a first acknowledgment packet corresponding to the first data packet is received by the first directional antenna.

18. The mobile device of claim 16, wherein determining whether the first directional antenna is valid comprises:
determining a first transmission strength corresponding to the first directional antenna using the first acknowledgment packet; and
determining whether the first transmission strength is less than a transmission strength threshold.

19. The mobile device of claim 18, wherein determining whether the transmission strength threshold is determined by calculating an average of the transmission strength signal indicator of at least one received packet received prior to the first acknowledgment packet on the mobile communications device.

20. The mobile device of claim 16, the method further comprising:
determining a first transmission strength corresponding to the first directional antenna using the first acknowledgment packet;
when the first transmission strength is less than the transmission strength threshold:
selecting a second directional antenna;
sending a second data packet from the second directional antenna; and
determining whether the second directional antenna is valid using the transmission strength threshold.

21. The mobile device of claim 20, wherein the first directional antenna and the second directional antenna use a single transceiver.

22. The mobile device of claim 20, wherein the second directional antenna is adjacent to the first directional antenna.
